(19) United States
(12) Patent Application Publication
(10) Pub. No.: US 2025/0375722 A1
(43) Pub. Date: Dec. 11, 2025

(54) FILTER DEVICE

(71) Applicant: AISAN KOGYO KABUSHIKI KAISHA, Obu-shi, Aichi-ken (JP)

(72) Inventors: Takuma UNO, Kariya-shi, Aichi-ken (JP); Takashi KANIE, Kariya-shi, Aichi-ken (JP); Masaru KAMEI, Nagoya-shi, Aichi-ken (JP); Shinya HIGASHI, Tokai-shi, Aichi-ken (JP)

(73) Assignee: AISAN KOGYO KABUSHIKI KAISHA, Obu-shi, Aichi-ken (JP)

(21) Appl. No.: 18/835,756

(22) PCT Filed: Jan. 17, 2023
(86) PCT No.: PCT/JP2023/001138

§ 371 Date: Jan. 31, 2025

(30) Foreign Application Priority Data
Feb. 8, 2022 (JP) 2022-017850

(51) Int. Cl. B01D 29/56; B01D 29/05; F02M 37/44

(52) U.S. Cl. CPC B01D 29/56; B01D 29/05; F02M 37/44; B01D 2201/4038

(57) ABSTRACT

A filter device (1) has at least one filter (30, 40) that includes three or more filter members stacked in a layered state. At least one of the inner filter members (32, 42) disposed inside the filter (30, 40) is a release filter member (33, 43) having at least one release portion that allows a foreign material to pass through without trapping the foreign material so as to avoid clogging of the filter device (1).

### TECHNICAL FIELD

This disclosure relates to filter devices.

### BACKGROUND

Japanese Laid-Open Patent Publication No. 2020-1004 discloses a filter device attached to a fuel pump that is disposed in the fuel tank of an automobile. The filter device includes two filters arranged at an upper and lower position. The two filters are formed into a flat bag-like shape with their peripheral edges welded to each other. Each filter is composed of a plurality of filter members stacked in a layered state.

In the filter device disclosed in the above gazette, the peripheral edges of the filter members of the filters are welded together to form a single unit. In such configuration, if one of the multiple filter members stacked in the layered configuration becomes clogged, the entire filter becomes clogged. Therefore, a filter device that can prevent clogging of the filter is desired.

### SUMMARY OF THE INVENTION

In one aspect of the present disclosure, a filter device includes at least one filter composed of three or more filter members stacked in a layered state. At least one of the filter members disposed inside the filter functions as a release filter member having one or more release portions that allow a foreign material to pass therethrough without trapping the foreign material.

### BRIEF DESCRIPTION OF DRAWINGS

FIG. 1 is a diagram showing one embodiment of a filter device connected to a fuel pump.

FIG. 2 is a cross-sectional view of the filter device.

FIG. 3 is an enlarged cross-sectional view of a structure of a filter.

FIG. 4 is an exploded view of the filter.

FIG. 5 is an exploded view showing a variant of a release filter member.

### EMBODIMENTS FOR CARRYING OUT THE INVENTION

### <Filter Device>

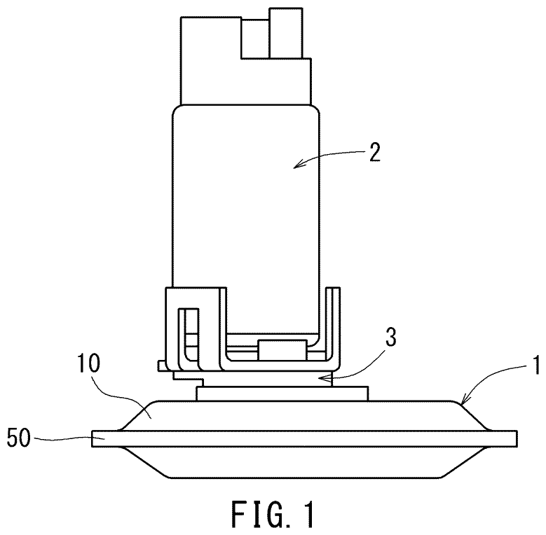

Various embodiments are described below in view of FIGS. 1-5. The filter device 1 shown in FIG. 1 is a fuel filter device installed in a fuel supply system that supplies fuel to an automobile engine. The filter device 1 is placed in a fuel tank. The filter device 1 is attached to an inlet of a fuel pump 2. The fuel pump 2 draws fuel from the fuel tank through the filter device 1. Thereby, clean fuel from which foreign materials have been removed can be supplied to the engine.

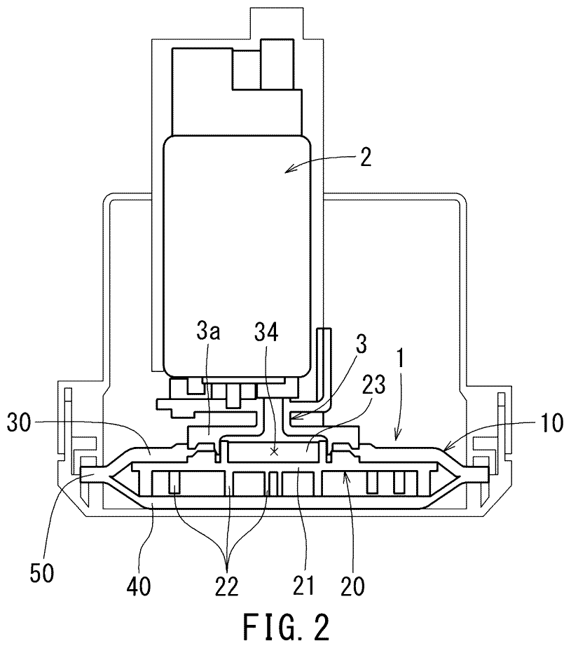

As shown in FIG. 2, the filter device 1 includes a filter body 10 that has a bag-like shape. The interior of the filter body 10 fluidly connects to the inlet of the fuel pump 2 through a connecting tube 3. The fuel pump 2 suctions fuel in the fuel tank through the interior of the filter device 1.

The filter body 10 includes an upper filter 30 and a lower filter 40 and has a flat shape. The upper filter 30 and the lower filter 40 are welded to each other along their peripheral edges to form a bag shape. The area where both filters are welded to each other is referred to as “welded portion 50”.

### <Inner Frame Member>

As shown in FIG. 2, the filter device 1 has an inner frame member 20. The inner frame member 20 is disposed between the upper filter 30 and the lower filter 40. The inner frame member 20 can be made of resin or the like. The inner frame member 20 has a flat plate portion 21 and a plurality of projections 22. The flat plate portion 21 extends in a horizontal direction. The projections 22 protrude downwardly from various parts of the flat plate portion 21. The inner frame member 20 supports the filter body 10 to prevent the filter body 10 from being crushed when a negative pressure is applied to the interior of the filter body 10 by the suction of the fuel pump 2. In other words, the inner frame member 20 is sandwiched between the upper filter 30 and the lower filter 40, thereby maintaining the distance between the upper filter 30 and the lower filter 40. Accordingly, the inner frame member 20 can secure the volume of the interior of the filter body 10. This allows fuel to flow throughout the interior of the filter body 10.

### <Connection to Fuel Pump>

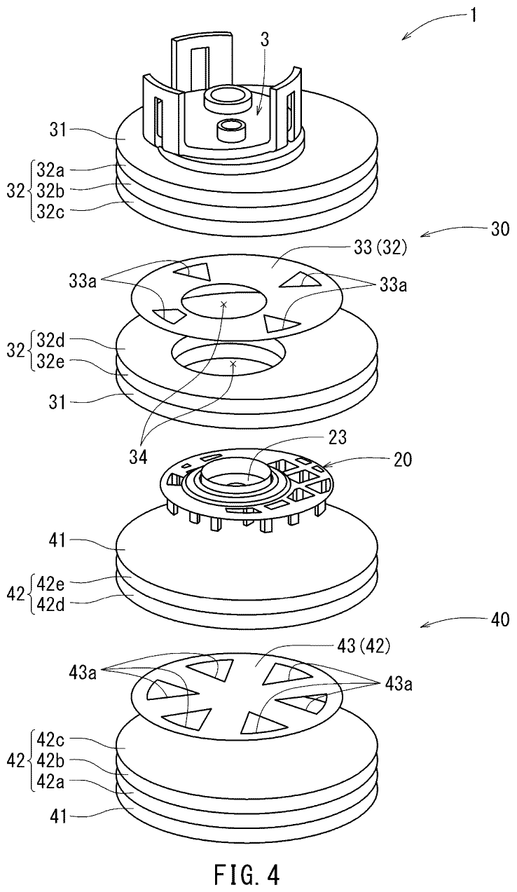

As shown in FIG. 2, the flat plate portion 21 is welded to a flange 3a of the connecting tube 3 from below. The flat plate portion 21 is welded to the flange 3a by ultrasonic welding, etc. Due to this welding, the upper filter 30 is integrally sandwiched between the flange 3a and the flat plate portion 21. Thereby, the filter body 10 is integrally assembled with the connecting tube 3. As shown in FIGS. 2 and 4, the inner frame member 20 has an outlet 23 for connecting the connecting tube 3.

### <Upper Filter>

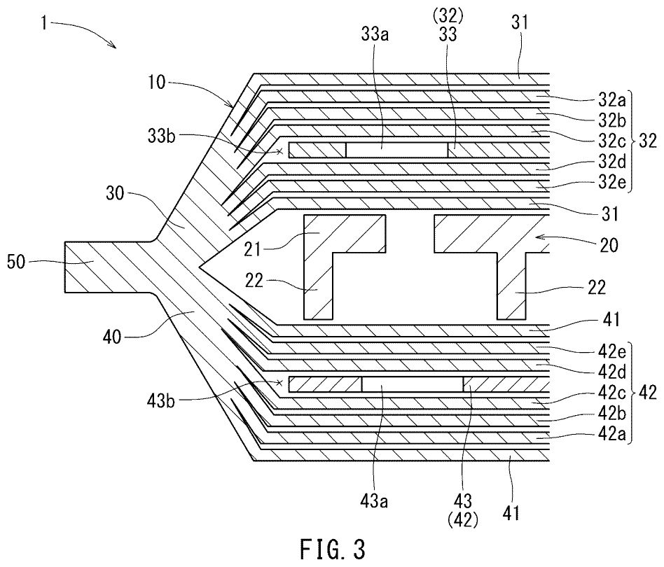

As shown in FIG. 3, each of the upper filter 30 and the lower filter 40 is integrated by layering a plurality of filter members. Each filter consists of an approximately circular non-woven fabric or the like. The upper filter 30 has two outer filter members 31 and one or more inner filter members 32. The outer filter members 31 form outer surfaces. The inner filter members 32 are located between the outer filter members 31.

In one embodiment, the inner filter members 32 may have six members. These inner filter members 32 are referred to as “first inner layer 32a”, “second inner layer 32b”, “third inner layer 32c”, “fourth inner layer”, “fifth inner layer 32d”, and “sixth inner layer 32e” that are positioned in order and along the direction in which the suctioned fuel passes through the upper filter 30 (from the upstream side to the downstream side). The upper filter 30 has an opening 34 which connects to the outlet 23 of the inner frame member 20. Fuel that flows into the interior of the filter device 1 is suctioned into the fuel pump 2 through the opening 34 and the outlet 23.

### <Release Filter Member>

As shown in FIGS. 3 and 4, at least one of the inner filter members 32 (e.g., the fourth inner layer) is configured as a release filter member 33. The release filter member 33 can suppress clogging of the upper filter 30. The release filter member 33 has apertures 33a. In one embodiment, the apertures 33a are formed at four locations of the top surface of the release filter member 33 in the circumferential direction. The ratio of the total area of the apertures 33a to the whole area of the release filter member 33 is set to be about 8%. Fuel flowing from the outside of the filter device 1 through the upper filter 30 to the inside of the filter device 1 can pass through each of the apertures 33a. The outer filter members 31 and the inner filter members 32, except the release filter member 33, are integrated at the welded portion 50. On the other hand, the release filter member 33 is smaller than the other inner filter members 32. Thereby, the periphery of the release filter member 33 and the welded portion 50 define a gap 33b therebetween. These apertures 33a and the gap 33b form spaces inside the upper filter 30. Therefore, the release filter member 33 can suppress the increase in pressure loss in the upper filter 30. Furthermore, the release filter member 33 can prevent the upper filter 30 from being clogged.

### <Filter Fineness>

The inner filter members 32, except the release filter member 33, can be configured so that the fineness thereof gradually becomes finer from the upstream side to the downstream side. In other words, the first inner layer 32a is made of the coarsest filter medium among the inner filter members 32. The sixth inner layer 32e is made of the finest filter medium among the same. Therefore, when the fuel passes through the upper filter 30, the inner filter members 32 capture foreign particles in order from the one having larger size. The outer filter members 31 can be made of a coarser filter medium than the first inner layer 32a. The outer filter members 31 have the role of trapping, for example, fibers separated from the inner filter members 32 to prevent the fibers from escaping to the outside of the upper filter 30.

The release filter member 33 can be made of a finer filter medium than the fifth inner layer 32d that is disposed right downstream of the release filter member 33. In this case, the release filter member 33 is easier to trap fine foreign materials than the fifth inner layer 32d. Therefore, the release filter member 33 would be clogged before the fifth inner layer 32d. However, the apertures 33a and the gap 33b allow the fuel flowing through the upper filter 30 to pass through the release filter member 33 without filtration. Therefore, the apertures 33a and the gap 33b function as release portions that allow fuel to pass through the release filter member 33 even when the release filter member 33 is clogged. Thus, the release filter member 33 can improve the filtration performance of the upper filter 30 and can prevent the upper filter 30 from being clogged. The release filter member 33 is made of a coarser filter medium than the sixth inner layer 32e.

### <Lower Filter>

As shown in FIGS. 3 and 4, the lower filter 40 has outer filter members 41 and inner filter members 42. In one embodiment, the inner filter members 42 may have six members. Fuel to be sucked into the fuel pump 2 passes through the lower filter 40 from the bottom to the top. The inner filter members 42 are referred to as “first inner layer 42a”, “second inner layer 42b”, “third inner layer 42c”, “fourth inner layer”, “fifth inner layer 42d”, and “sixth inner layer 42e” along this direction (from the upstream side to the downstream side).

### <Release Filter Member>

As shown in FIGS. 3 and 4, at least one of the inner filter members 42 (e.g., the fourth inner layer) is configured as a release filter member 43. The release filter member 43 can suppress clogging of the lower filter 40. The release filter member 43 has apertures 43a. In one embodiment, the apertures 43a are formed at six parts of the top surface of the release filter member 43 in the circumferential direction. The ratio of the total area of the apertures 43a to the whole area of the release filter member 43 is set to be about 20%. Fuel flowing from the outside of the filter device 1 to the inside through the lower filter 40 can pass through the apertures 43a. The release filter member 43 is smaller than the other inner filter members 42. Thereby, the periphery of the release filter member 43 and the welded portion 50 define a gap 43b therebetween. These apertures 43a and the gap 43b form spaces inside the lower filter 40. Therefore, the release filter member 43 can suppress the increase in pressure loss in the lower filter 40. Furthermore, the release filter member 43 can prevent the lower filter 40 from being clogged.

### <Filter Fineness>

The inner filter members 42, except the release filter member 43, can be configured so that the fineness thereof gradually becomes finer from the upstream side to the downstream side in the fuel flow direction. In other words, the first inner layer 42a is made of the coarsest filter medium among the inner filter members 42. The sixth inner layer 42e is made of the finest filter medium among the same. The outer filter members 41 are made of a filter medium that is coarser than the first inner layer 42a. The outer filter members 41 have the role of trapping, for example, fibers separated from the inner filter members 42 to prevent the fibers from escaping to the outside of the lower filter 40.

The release filter member 43 is made of a filter medium that is finer than the fifth inner layer 42d that is disposed right downstream of the release filter member 43. In this case, the release filter member 43 is easier to trap fine foreign materials than the fifth inner layer 42d. Therefore, the release filter member 43 would be clogged before the fifth inner layer 42d. However, the apertures 43a and the gap 43b function as the release portions that allow the fuel flowing through the lower filter 40 to pass through the release filter member 43 without filtration. Therefore, the fuel can pass through the release filter member 43 even when the release filter member 43 is clogged. Thus, the release filter member 43 can improve the filtration performance of the lower filter 40 and prevent the lower filter 40 from being clogged. The release filter member 43 is made of a coarser filter medium than the sixth inner layer 42e.

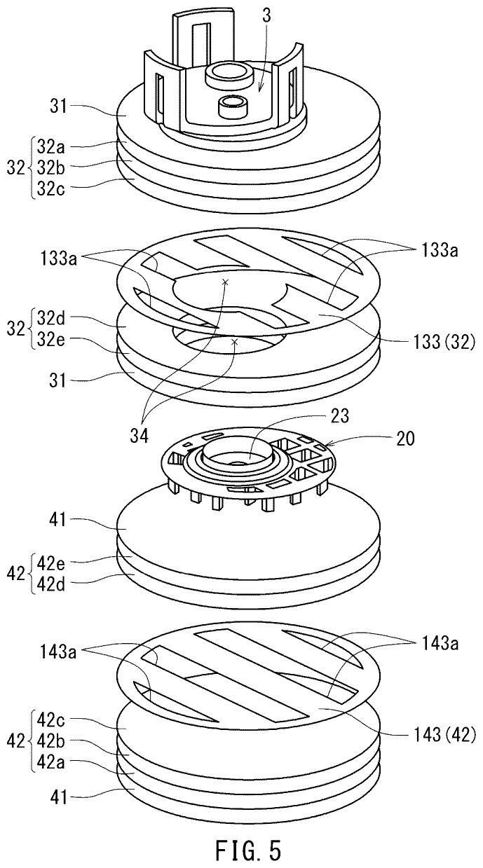

As shown in FIG. 5, in another embodiment, peripheral edges of the release filter members 133, 143 may be integrated with the welded portion 50 without the gaps 33b, 43b. Therefore, the release filter members 133, 143 are roughly the same size as the outer filter members 31, 41 and the inner filter members 32, 42, except the release filter members 133, 143. The release filter members 133, 143 have only apertures 133a, 143a as the release portions. The apertures 133a, 143a are open in the form of strips and are aligned at predetermined intervals.

### Advantages

In summary, the filter device 1 has at least one of the filters 30, 40 of which each comprises three or more filter members superimposed in a layered configuration. At least one of the inner filter members 32, 42 disposed inside the filters 30, 40 functions as the release filter members 33, 43 in which each has a release portion that allows foreign materials to pass through without being trapped. Due to this configuration, the release portions form spaces inside the filters 30, 40. Even if the filters 33, 43 become clogged, the release portions allow fluid to pass through the release filter members 33, 43. These features can suppress the pressure loss in the filters 30, 40 and prevent the filters 30, 40 from being clogged.

The apertures 33a, 43a formed in the release filter members 33, 43 function as at least one of the release portions. Due to this configuration, the release portions can be easily formed by simply making holes in the release filter members 33, 43.

The filters 30 and 40 are integrated by the welded portion 50 where the peripheries of the filters are welded to each other. The welded portion 50 does not adhere to the release filter members 33, 43. Each gap 33b, 43b formed between the corresponding release filter member 33, 43 and the welded portion 50 functions as the release portion. This configuration allows the release portions to be formed without drilling holes or other processing in the release filter members 33, 43. Also, the thickness of the welded portion 50 can be made thinner by not welding the release filter members 33, 43. This makes it easier to form the welded portion 50.

The release filter members 33, 43 are finer than the filter members located right downstream of the release filter members 33, 43. Due to this configuration, the release filter members 33, 43 would be clogged before the filter members right downstream of the corresponding release filter members 33, 43.

The filter device 1 is configured as a fuel filter device used in a fuel supply system that supplies fuel to the engine of a vehicle. Furthermore, the filter device 1 is connected to the inlet of the fuel pump 2 that pumps the fuel in the fuel tank to the engine. The filter device 1 can reduce clogging of the filters 30, 40 when filtering the fuel that is sucked into the fuel pump 2, thereby improving the filter performance.

### Other Embodiments

In another embodiment, the filter device can be applied to various filters such as air filter and wastewater filter, in addition to fuel filter. The filter device can also be applied to fuel filters for motorcycles, ships, and other vehicles, in addition to fuel filters for automobiles.

In another embodiment, the bag-shaped filter body can have cylindrical, spherical, or any other shape instead of flat shape. Although the above-described filter body is composed of two filters welded together, it may be formed into a bag shape by folding a single filter and welding the peripheral edges thereof. In another embodiment, the filter body may have a single filter having a layered configuration, instead of bag-like shape.

In another embodiment, the filter members can be made of any filter medium other than non-woven fabric.

In another embodiment, the most downstream one of the outer filter members of the filters may consist of the finest filter medium among the filter members. The outer filter member may have a release portion such as an opening.

In another embodiment, the filter may include arbitrary number of the inner filter members other than six. The inner filter member may consist of only one release filter member. Although the inner filter members gradually become finer from the upstream side to the downstream side along the direction of fuel flow in the above-described examples, the filter member in the upstream side may be finer. The inner filter members may be composed of filter media with different fineness from each other. All or some of the inner filter members may be made of the filter media having the same fineness.

In another embodiment, the release filter member may not have an aperture and may form the release portion only in the gap between the release filter member and the fixing portion. The gap between the release filter member and the fixing portion may be formed at a part of the periphery of the release filter member. The number and shape of the apertures may be freely changed from those of the above-described embodiments.

In another embodiment, the release filter member may be made of a different material than the other inner and outer filter members except for the release filter member. The release filter member can be provided in any layer inside the filter. Two or more release filter members may be installed, instead one. In such case, the release filter members can be next to each other, or can be arranged to interpose other inner filter member(s) without release portion therebetween. When multiple release filter members are provided, the release filter members may have apertures and/or form a gap together with the fixing portion as the release portion. One of the release filter members may have only the apertures and the other of the release filter members may define only the gap together with the fixing portion.

In another embodiment, the release filter member may be finer than the other inner filter members that do not have the release portion.

Although various embodiments have been described above, the present disclosure is not limited to those embodiments. Those skilled in the art can carry out various modifications, substitutions, and improvements for the disclosure.

The various examples described above in detail with reference to the accompanying drawings are representative examples of the disclosure and are not intended to limit the disclosure. The detailed description is intended to teach making, using and/or practicing the various aspects of the present disclosure to those skilled in the art and is not intended to limit the scope of the disclosure. Furthermore, each of the additional features and teachings described above may be applied and/or used separately or in conjunction with other features and teachings to provide improved filter devices and/or methods of making and using the same.

1. A filter device, comprising:
at least one filter composed of three or more filter members stacked in a layered configuration,
wherein at least one of the filter members disposed inside the filter functions as a release filter member having one or more release portions that allow a foreign material to pass through without trapping the foreign material.

2. The filter device according to claim 1,
wherein at least one of the release portions is an aperture being formed in the release filter member.

3. The filter device according to claim 1 or 2, wherein:
a fixing portion fixes peripheral edges of the filter members excluding the release filter member to each other to integrally form the filter;
the release filter member is not fixed to the fixing portion; and
at least one of the release portions is a gap formed between the release filter member and the fixing portion.

4. The filter device according to any one of claims 1 to 3,
wherein the release filter member is finer than a filter member placed right downstream of the release filter member in a flow direction of a fluid being filtered.

5. The filter device according to any one of claims 1 to 4, wherein:
the filter device is a fuel filter device used in a fuel supply system that supplies fuel to an engine of a vehicle; and
the filter device is configured to connect to an inlet of a fuel pump that supplies fuel from a fuel tank to the engine.
